(19) United States
(12) Patent Application Publication
(10) Pub. No.: US 2025/0019208 A1
(43) Pub. Date: Jan. 16, 2025

(54) ELEVATOR SYSTEM FOR SERVING FLOORS IN A BUILDING WITH MIXED USE

(71) Applicant: Inventio AG, Hergiswil (CH)

(72) Inventors: Lukas Finschi, Ebikon (CH); Florian Trösch, Erlenbach ZH (CH)

(21) Appl. No.: 18/714,535

(22) PCT Filed: Dec. 12, 2022
(86) PCT No.: PCT/EP2022/085378

§ 371 Date: May 29, 2024

(30) Foreign Application Priority Data
Dec. 22, 2021 (EP) 21216709.2

(51) Int. Cl. B66B 13/14; B66B 1/34; B66B 13/06; B66B 13/30

(52) U.S. Cl. CPC B66B 13/146; B66B 1/3492; B66B 13/06; B66B 13/305; B66B 13/306

(57) ABSTRACT

The invention relates to an elevator system comprising an elevator car which has two car doors with electrically controllable door elements. A first car door is arranged on a first car wall and comprises a first electrically controllable door element. A second car door is arranged on a second car wall and comprises a second electrically controllable door element. The first door element and the second door element each have at least two visual permeability states, wherein a first visual permeability state allows a passenger to see through the door element and wherein a second visual permeability state obstructs a passenger's view through the door element. An elevator controller determines a car door to be opened and controls the door element of the car door to open in accordance with the first visual permeability state to allow viewing through the door element of the car door to be opened.

### TECHNICAL FIELD

The disclosure herein relates in general to an elevator system in a building. Exemplary embodiments of the presentdisclosure relate in particular to a configuration of an elevator car of the elevator system and a method for operating such an elevator system.

### SUMMARY

Buildings are usually designed and constructed for a single use or for mixed use. A residential building is an example of a single use, as is an office building. A mixed use exists if, for example, a building comprises apartments and commercially used space. An elevator system installed in the building is adapted for the respective type of use. Depending on the building, the elevator system can have a single elevator, an elevator group or a plurality of elevator groups: in addition, one or more special elevators (e.g., freight elevators) can be provided.

Over time, the originally planned use of the building can change for various reasons. The need for office space or commercial space in general may decline due to changing life and work circumstances, for example. In an office building, for example, vacant space on one or more floors can be converted into apartments. In the event of such a change of use. the elevator system installed in the building remains substantially as it was adapted for the originally planned use of the building.

Although the elevator system is still available for transporting persons and goods after the change of use, it may be necessary or desirable, depending on the building and its use, for the elevator system to be adaptable to the changed use. There is therefore a need for a technology that fully or at least partially meets these requirements.

One aspect of the present disclosure relates to an elevator system comprising an elevator controller and an elevator car. The elevator car can be moved between floors of a building in an elevator shaft controlled by the elevator controller and can have two car doors with electrically controllable door elements. A first car door can be arranged on a first car wall and can comprise a first electrically controllable door element. A second car door can be arranged on a second car wall and can comprise a second electrically controllable door element. The first electrically controllable door element and the second electrically controllable door element each can have at least two visual permeability states, wherein a first visual permeability state can allow a passenger to see at least partially through the electrically controllable door element and wherein a second visual permeability state can substantially obstructs a passenger's view through the electrically controllable door element. The elevator controller can control the movement of the elevator car and can be communicatively coupled to the electrically controllable door elements. The elevator controller can be configured to determine a car door to be opened and to control the electrically controllable door element of the car door to be opened in accordance with the first visual permeability state, in order to at least partially allow viewing through the controllable door element of the car door to be opened.

Another aspect of the present disclosure relates to a method for operating an elevator installation. In this case, the elevator installation can be designed as described herein. According to the method, the elevator controller can determine which of the two car doors is to be opened at the next stop of the elevator car, and the elevator controller can generate a door control signal indicating the car door to be opened. The electrically controllable door element of the car door to be opened can be controlled with the door control signal in accordance with the first visual permeability state, in order to at least partially allow viewing through the electrically controllable door element of the car door to be opened.

The present disclosure can be used advantageously in a building with mixed use, for example. Such mixed use of a building exists, for example, if the building comprises apartments and commercial space (e.g., office, storage and/or store space) or if there is only commercial space used by different businesses. Passengers, e.g., user groups such as residents and persons using the commercial space, can be transported by the elevator system, without one user group encountering or becoming aware of another user group when using the elevator system.

The present disclosure can make it possible, among other things, to guide and direct passengers and persons. If the elevator system is used by a user group for a ride, viewing may be at least partially allowed by the electrically controllable door element of the car door, e.g., during the ride to the next stop, which will open. The present disclosure can prepare the passenger for disembarking and can guide the passenger towards the exit side; if necessary, the passenger can turn towards the exit side before stopping on the floor, for example.

In one exemplary embodiment, the car door, which is not opened, can remain in the second visual permeability state, so that a passenger's view through the electrically controllable door element of this car door remains substantially obstructed. Depending on the configuration of the electrically controllable door element, the view can be obstructed by the fact that it is not transparent or opaque in the second visual permeability state. This non-visual permeability can, for example, allow the outline of a passenger to be recognized, but it can also prevent visible light from passing through. In some applications, it may also be sufficient if the view is refracted in the second visual permeability state. The passenger can therefore be denied a view from the elevator car in this direction and thus also a view of a floor or part of the building that is available to another user group, for example. The privacy of this other user group can therefore preserved.

In one exemplary embodiment, the elevator system can have shaft doors which separate the floors from the elevator shaft. There can be two shaft doors on at least one floor. A first shaft door can be arranged on a first building wall and can have a first electrically controllable shaft door element. A second shaft door can be arranged on a second building wall and can 3onf a second electrically controllable shaft door element. The first shaft door element and the second shaft door element each can have at least two visual permeability states: a first visual permeability state that can at least partially allow a passenger to see through the electrically controllable shaft door element, and 3onfigd

Visual permeability state that can substantially obstructs a passenger's view through the electrically controllable shaft door element. Each electrically controllable shaft door element can be configured to assume the first visual permeability state in response to an electrical control signal indicating a shaft door to be opened, in order to at least partially allow viewing through the electrically controllable shaft door element of the shaft door to be opened. The door elements of the car doors and shaft doors can be controlled, for example, so that the door element of a shaft door to be opened is also in the first visual permeability state when the elevator car arrives. If the door elements of the doors to be opened (e.g., car and shaft doors) are transparent, passengers waiting on the floor, for example, can see whether passengers are about to disembark: this can also apply in the opposite direction in an analogue manner.

This exemplary embodiment also contributes to the preservation of privacy described herein. In the case of shaft doors that are arranged on opposite shaft walls corresponding to the car doors, the relevant door elements of the doors can be controlled in such a way that at no time is it possible to see across the elevator shaft to the other part of the building (e.g., at least one door element of a door that is not to be opened substantially obstructs the view), When using the elevator system, for example, a resident may not recognize that a ride passes, begins or ends on a floor that is used wholly or partially for commercial purposes. The privacy of the various user groups can therefore be preserved.

The control of the shaft door elements may not be limited to one type. In one exemplary embodiment, each electrically controllable shaft door element can be communicatively coupled to the elevator controller. The elevator controller can thus control each shaft door element individually. In a further exemplary embodiment, each electrically controllable shaft door element can have an electrical contact element, which can be configured to be complementary to an electrical contact element arranged on or near each of the car doors. The electrical contact elements can transmit the electrical control signal if a car door couples to a shaft door.

The configuration of the electrically controllable door elements may also not be limited to one type. In one exemplary embodiment, the door elements can comprise glass inserts inserted into the car doors. A glass insert can comprise smart glass, also known as dynamic or switchable glass. In the first visual permeability state, the glass insert can be substantially transparent (to light visible to humans) and in the second visual permeability state, the glass insert can be substantially opaque.

In one exemplary embodiment, the door elements can comprise electromechanically adjustable slat systems inserted into the car doors. A slat system, for example, can have an adjustment mechanism and strip-shaped slats of a fixed length, width and thickness. wherein a slat can be much wider than it is thick. In the first visual permeability state, the slats of the slat system can be adjusted so that substantially there is visual permeability. e.g., a passenger substantially sees the wide surfaces of the slats. In the second visual permeability state, the slats can be adjusted so that substantially there is no visual permeability, e.g., a passenger substantially sees the thin sides of the slats. The slats can be arranged vertically or horizontally, e.g., from a passenger's perspective, they extend in the longitudinal direction of the doors or across the width of a door.

In one exemplary embodiment, the elevator system can have a device for determining a position of the elevator car in the elevator shaft. The elevator controller can use the specific position information, for example, when planning a ride and while the elevator car is moving. The elevator controller can be configured to control the electrically controllable door element of the car door to be opened during a ride from a boarding floor to a stopping floor, on which the elevator car stops while the elevator car is moving. This can make it possible, for example, to ensure that the visual permeability state to be set already exists when the door is stopped, even if the door element requires an inherent time to set the visual permeability state. This can also contribute to the above-mentioned guiding of passengers.

Position determination can be used to adjust the visual permeability settings during a ride. e.g., to ensure privacy. In one exemplary embodiment, the use of a floor or part of a building defined in a building plan can be used to determine whether the ride passes at least one floor or part of a building that is defined as visible or not visible in the building plan. The electrically controllable door elements of the car door and/or the shaft door elements can be controlled while the car is moving in the first or second visual permeability state, depending on the use defined in the building plan, Whether a floor or part of a building is visible or not can be determined by individual persons or by a building manager. For example, commercially used floors may never be visible during the ride: this may apply to a ride by a resident who passes a commercial floor, but also to other persons (commercial users). In one exemplary embodiment, the visibility or non-visibility can be defined specifically for the user groups: for example, the “residents” user group can see the residents' floors from the elevator car, but not the commercial floors. and vice versa.

The present disclosure is not limited to an elevator system with a single elevator car or a single elevator. The elevator system can also comprise a plurality of elevator cars or elevators that form an elevator group. A plurality of elevator groups can also be used.

### BRIEF DESCRIPTION OF THE DRAWINGS

Various aspects of the present disclosure are described in greater detail herein in conjunction with the drawings with reference to exemplary embodiments. In the figures, identical elements have identical reference signs. In the drawings:

FIG. 1 is a schematic view of an exemplary situation in a building with a plurality of floors and of an example of an elevator system:

FIG. 2 is a schematic representation of controlled car doors and shaft doors:

FIG. 3a-3b are schematic representations of exemplary slat systems: and

FIG. 4 is an exemplary representation of an exemplary embodiment of a method for operating the elevator system.

### DETAILED DESCRIPTION

FIG. 1 is a schematic representation of an exemplary situation in a building 2, which has a plurality of floors L0, L, Ln and an elevator system 1 with at least one elevator car 10. which serves the floors L0, L, Ln along an elevator shaft 18. In the exemplary embodiments described here, the building 2 is a building with mixed use in which, for example, there are apartments and commercially used space. The building 2 may have originally been planned for mixed use, but the mixed use may also have arisen over time following a corresponding adaptation or conversion of the building 2.

In the exemplary building situation shown in FIG. 1. the disclosure described herein can be used in an advantageous manner. Briefly and by way of example, the present disclosure can enable the elevator system 1—in addition to its transportation function in the building 2 with mixed use—to help guide passengers using the elevator system 1 and maintain their privacy. The elevator car 10 has two car doors 10a, 10b with electrically controllable door elements 9a, 9b. Each door element 9a, 9b can have at least two visual permeability states. wherein a first visual permeability state can allow a passenger to see at least partially through the door element 9a, 9b and wherein a second visual permeability state can substantially obstructs a passenger's view through the electrically controllable door element 9a, 9b. An elevator controller 13 can be configured to determine a car door 10a, 10b to be opened in response to an elevator call and to control the door element 9a, 9b of the car door 10a, 10b to be opened in accordance with the first visual permeability state. in order to at least partially allow viewing through the electrically controllable door element 9a, 9b of the car door 10a, 10b to be opened. The passenger may therefore see which car door 10a, 10b will open. The door element 9a, 9bof the car door 10a, 10b. which is not opened. can be in the second visual permeability state, so that a passenger's view through the electrically controllable door element of this car door remains substantially obstructed.

Depending on the configuration of the door elements 9a, 9b and the shaft door elements 6a, 7a also present in the elevator system 1, the term “visual permeability” describes how the view through the door element is more or less impaired. With a transparent door element, the view may not substantially be impaired, because it is translucent or transparent. With an opaque door element, the view can be so severely impaired that it allows no or very little light through, making it virtually non-transparent. In addition to these extremes of transparent and opaque, a material can also be translucent, e.g., partially transparent. Depending on the application, it may be sufficient not to completely obstruct the view, but merely to more or less break it up; for example, it may be acceptable or desirable for a person behind a pane of glass to be dimly perceptible (visible) without it being possible to recognize who they are. As explained herein, the visual permeability states can be implemented in various ways.

Referring again to the situation shown in FIG. 1, the upper floors (Ln) can, for example, be exclusively residential floors, each having at least one apartment, and the lower floors (LO) can be exclusively commercially used floors (hereinafter also referred to as commercial floors). In addition to these exclusive uses, a part of the building on one floor can be used for at least one apartment (“residential part of the building”) and another part of the building can be used for commercial purposes (“commercial part of the building”). For example, a business can use one or more floors L0, L. If there is a plurality of floors. these can be consecutive in the vertical direction, e.g., the business uses the neighboring floors L0 and L, but one or more floors can also be non-consecutive, e.g., there is at least one floor not used by the business between two floors used by the business. In the latter case, a floor not used by this business can be used by another business or for one or more apartments: on this unused floor, one part of the building can be used for residential purposes and another part of the building for commercial purposes. A person skilled in the art will recognize that, like the commercial floors, the residential floors may not be consecutive.

A person skilled in the art will also recognize that the present disclosure is not limited to mixed use by apartments and businesses, but also includes sole use by commercial users (e.g., various businesses). For example, one or more floors or parts of a building can be used by a hotel company, while other floors or parts of a building on these floors can be used by other businesses (e.g., stores, law firms, etc.). The following description refers to mixed use by apartments and businesses by way of example.

The elevator system 1 installed in the building 2 is configured to serve the floors L0, L, Ln in accordance with the usage scenarios described herein. Residents of the apartments can use elevator system 1 to be transported from one residential floor (residential part of the building) to another residential floor (residential part of the building) or to a building access floor (entrance hall), or to be transported from the entrance hall to a residential floor (residential part of the building). Accordingly, persons (e.g., employees, hotel guests, visitors, etc.) who use the floors for commercial purposes can be transported between the individual commercial floors and between the commercial floors and the entrance hall. Depending on the building 2, both user groups (residents and other persons) can use the same entrance hall, but separate entrances to the elevator system 1 can also be provided. The building 2 can also have separate entrance halls (e.g., on different floors). A person skilled in the art will recognize that the elevator system 1, possibly in conjunction with an access control system, can be configured to detect and verify credentials before a resident or other person can be transported to a floor.

In the exemplary situation shown in FIG. 1, a part of the building B to the left of the elevator shaft 18 on the floor L, for example, can be used for commercial purposes. Persons therefore can use the elevator system 1 from this left-hand commercial part of the building B, e.g., while a person is in the commercially used commercial part of the building B, they can input an elevator call there, for example, and then can board the elevator car 10 that serves the elevator call from there. In FIG. 1, a residential part of the building R to the right of the elevator shaft 18 can be used for residential purposes. The residents therefore can use the elevator system 1 from this (right-hand) residential part of the building R. The parts of the building B and R can be separated from one another by structural measures (e.g., walls). A person skilled in the art will recognize that other floors L0, Ln can also be divided into parts of the building. As described herein, the elevator system 1 can recognize on which floor L0, L, Ln and in which part of the building B, R an elevator call is input and which destination (floor Lo, L, Ln, and/or part of the building B, R) a passenger has.

The use of the building 2, for example its division into floors L0, L, Ln, the arrangement of any parts of the building B, R and the accesses to the building 2 and the elevator system 1 can be defined in a building plan in one exemplary embodiment. The building plan can be stored in electronic form in the elevator system 1 or in a building management system. The elevator system I can use this stored building plan, for example, when planning an elevator ride. If, for example, the use and/or layout of the floors L0, L, Ln or parts of the building B, R changes in the building 2, the building plan can be updated at a central location.

For the purposes of illustration, FIG. 1 shows only the elevator controller 13, a drive machine 14, a suspension means 16 (e.g., steel cables or flat belts), and an elevator car 10 (hereinafter also referred to as car 10), which is suspended on the suspension means 16 and is movable in the elevator shaft 18 under the control of the elevator controller 13, and a number of elevator operating devices 4 of the elevator system 1. The elevator controller 13 can comprise a plurality of functions, which are shown in FIG. 1 by a control and processing device 12 (Ctrl), a drive control 8 (EC) and a position determining device 20 (P). The control and processing device 12, the drive control 8 and the position determining device 20 can, for example, be combined in one unit (elevator controller 13) and arranged at a central location in the elevator shaft 18 (e.g., in the shaft head): they can also be arranged separately and/or distributed. Functions of the elevator controller 13 can also be carried out in whole or in part by the elevator operating devices 4 and/or by components of the elevator car 10 or components arranged thereon. A person skilled in the art will recognize that the elevator system I can also comprise a plurality of cars 10 in one or more shafts 18: a plurality of cars 10 can form an elevator group that is controlled by a group controller. The elevator system I can also comprise a plurality of elevator groups. Instead of a traction elevator (shown in FIG. 1), the elevator system I can also have one or more hydraulic elevators.

The elevator car 10 shown in FIG. 1 has the (first) car door 10a on a first car wall 10d and the (second) car door 10b on a second car wall 10c, In the exemplary embodiment shown. the car walls 10c, 10d and thus the car doors 10a, 10b are arranged opposite one another: in a further exemplary embodiment, the car walls 10c, 10d can be arranged adjacent to one another (e.g, at right angles). Regardless of their arrangement, the car doors 10a, 10b (or their electrical components, as described herein) can be connected to the elevator controller 13 via a communication network 24.

A person skilled in the art will recognize that the car door 10a, 10b can be configured in different ways. In one configuration, it can comprise a sliding door, the door leaves of which are laterally displaceable, driven by an electric motor: the sliding door can open left, centrally or right. The sliding door can also comprise a multi-part telescopic door system. In another design, the car door 10a, 10b can be configured as a hinged door or pivoting door: in this design, one or two door leaves can each be pivoted on the car wall. A person skilled in the art therefore understands the term “car door” to mean a door system with one or more door leaves that open and close access to the car 10, irrespective of a specific design.

FIG. 1 also shows a number of shaft doors 6, 7 which separate the elevator shaft 18 from the floors L0, L, Ln. These shaft doors 6, 7 can be designed according to one of the designs mentioned with regard to the car doors 10a, 10b. In the embodiment shown, two shaft doors 6, 7 are arranged on each floor L0, L, Ln: a person skilled in the art will recognize that only one shaft door 6, 7 can be arranged on one or more floors L0, L, Ln. In addition, the person skilled in the art will recognize that the elevator shaft 18 or its walls are generally part of the building 2 and walls of the elevator shaft 18 can also be building walls. The shaft doors 6, 7 can therefore be understood (as is also the case herein) as being arranged on the building walls. A person skilled in the art will recognize that the arrangement of the shaft doors 6, 7 can also be understood as being arranged on the shaft walls.

In one exemplary embodiment, a shaft door 6, 7 can be opened and closed by being coupled to one of the car doors 10a, 10b if the elevator car 10 is located on the floor Lo, L, Ln and can thereby be moved by the car door 10a, 10b. The arrangement of the shaft doors 6, 7 (e.g., opposite one another) can correspond to the arrangement of the car doors 10a, 10b. In one exemplary embodiment, the shaft doors 6, 7 (or their electrical components) can be communicatively coupled to the elevator controller 13 via the communication network 24; in FIG. 1. this coupling is shown schematically on floors L0, L. In a further exemplary embodiment, each shaft door 6, 7 can have an electrical contact element 11 which can face the elevator shaft 18 and which can come into electrical contact with a complementary contact element 15 on the car 10 if the car 10 stops at a floor. The contact elements 11 on the floor Ln are shown schematically in FIG. 1. Such contact elements are known to a person skilled in the art. An electrical control signal can be transmitted to a shaft door 6, 7 (or an electrical component of the shaft door 6, 7) by coupling via the communication network 24 or contacting via the contact elements 11, 15. In one exemplary embodiment of the elevator system 1, either the above-mentioned coupling via the communication network 24 or contacting via the contact elements 11, 15 can be implemented.

A communication network 22 can connect the elevator operating devices 4 to the elevator controller 13 and thus can make communication possible between the elevator controller 13 and the elevator operating devices 4. For this communication, the elevator operating devices 4 and the elevator controller 13 may be directly or indirectly connected to the communication network 22.

The communication networks 22, 24 can each comprise a communication bus system. individual point-to-point lines, or a combination thereof. Depending on the implementation of the communication networks 22, 24. the elevator controller 13, each elevator operating device 4, each car door 10a, 10b and each shaft door 6, 7 can be assigned individual addresses and/or identifiers, so that, for example, the elevator controller 13 can address and send a message specifically to a particular elevator operating device 4 or a control signal to a particular car door 10a, 10b. Communication can take place in accordance with a protocol for wired communication, for example, the Ethernet protocol. With the above-mentioned addressing or the point-to-point line connection, the elevator controller 13 (e.g., in conjunction with the above-mentioned building plan) can recognize, among other things, on which floor L0, L, Ln, in which part of the building (B, R) and at which elevator operating device 4 a resident or other person inputs an elevator call. The recognized floor L0, L, Ln or the recognized part of the building (B, R) can specify a boarding location (boarding floor and boarding side into the car 10) for a desired ride to a destination floor.

In one exemplary embodiment, the elevator operating devices 4 can be supplied with electrical power via the communication network 22: this is also known as “Power over Ethernet” (PoE). If an elevator operating device is arranged in the car 10 (e.g., if. according to a control technology of the elevator system 1. a desired destination floor is to be input in the car 10), a corresponding communication line can be provided in one exemplary embodiment for communication and for supplying power to the elevator operating device. FIG. 1 shows no such communication line and no elevator operating device for call input in the car 10: however, the person skilled in the art will recognize that the car 10 has an elevator operating device which comprises, for example, buttons for an emergency call and door commands (open/close) and, depending on the control technology, can comprise buttons for inputting a desired destination floor.

In one exemplary embodiment, the car doors 10a, 10b can each comprise a door element 9a, 9b, which can assume the at least two states of visual permeability and which controls the elevator controller 13 with an electrical control signal described herein. According to one exemplary embodiment, the door element 9a, 9b can comprise a glass panel which has fixed dimensions ((vertical) length, width, thickness) for the car door 10a, 10b. According to one exemplary embodiment, these dimensions, in particular length and width, can substantially correspond to a dimension of the relevant car door 10a, 10b, e.g., the car door 10a, 10b is substantially a glass door. Depending on the configuration, a metal frame structure, for example, can completely or partially surround the glass panel. In a further exemplary embodiment, the dimensions of the door element 9a, 9b can be smaller than the dimensions of the respective car door 10a, 10b; e.g., the door element 9a, 9b can be located in a part of the car door 10a, 10b, for example, the door element 9a, 9b can completely or partially occupy an upper half of the car door 10a, 10b. A person skilled in the art will recognize that a different division is also possible and that a car door 10a, 10b can comprise a plurality of door elements 9a, 9b.

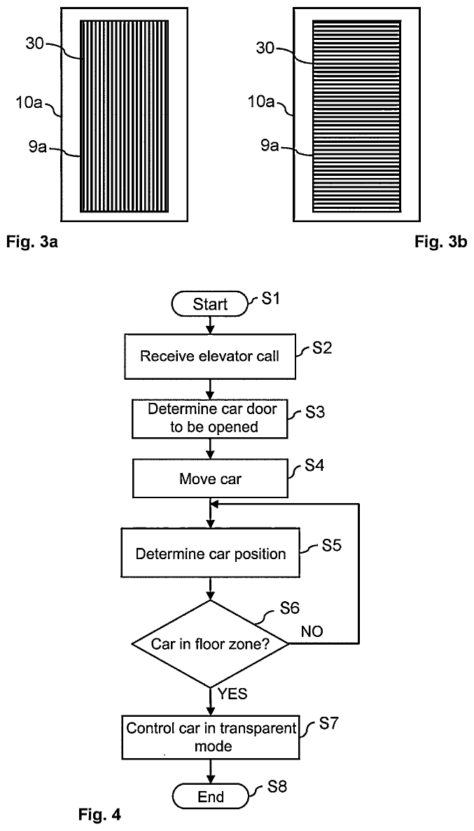

In a further exemplary embodiment, a door element 9a, 9b can comprise an electromechanically adjustable slat system 30. The slat system 30 has an adjusting mechanism and a plurality of slats (e.g., strip-shaped elements made of metal, plastics, fabric or a combination thereof), which can be rotatably mounted about their longitudinal axis, in order to be able to set a desired angle of rotation: the slats can also be displaceable relative to one another, so that they overlap to a greater or lesser extent. Such slat systems 30 are known to a person skilled in the art, for example, in the field of blinds for windows. FIG. 3a shows the slat system 30 with a vertical arrangement of the slats.

and FIG. 3b shows the slat system 30 with a horizontal arrangement of the slats. A person skilled in the art will recognize that the slats can also be arranged in a different way and that the slats can be arranged between two panes of glass for protection, for example.

In one exemplary embodiment, the shaft doors 6, 7 can be configured in the same way as the car doors 10a, 10b. For example, on a floor L0, L, Ln with two shaft doors 6, 7, the (first) shaft door 6 can be arranged on a first building wall and comprises a (third) electrically controllable door element 6a. The (second) shaft door 7 can be arranged on a second building wall and comprises a (fourth) electrically controllable door element 7a. On the floor L, the shaft door 6 can open in the direction of the part of the building B and the shaft door 7 can open in the direction of the part of the building R. The door elements 6a, 7a likewise can have at least two visual permeability states and can be communicatively coupled to the elevator controller 13 in one of the ways described herein, in order to control the door element 6a, 7a of a shaft door 6, 7 to be opened in accordance with the first visual permeability state.

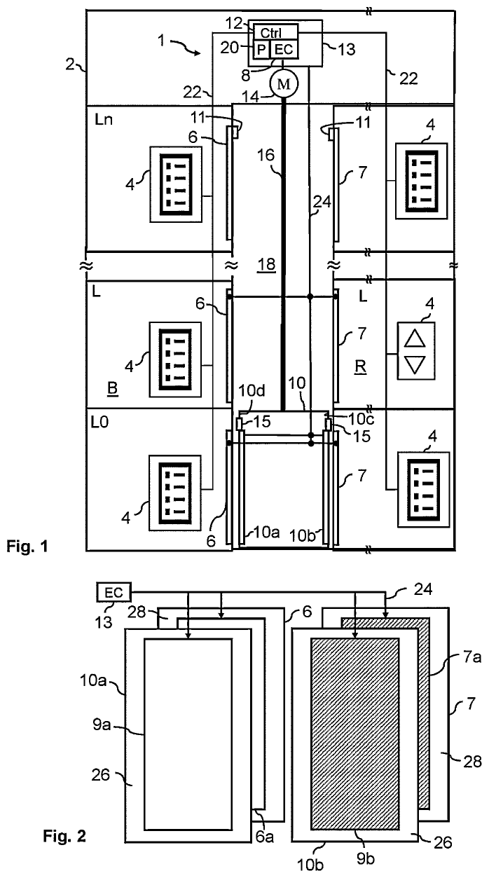

FIG. 2 shows an exemplary embodiment of the car doors 10a, 10b and the shaft doors 6, 7. wherein the shaft doors 6, 7 are partially concealed by car doors 10a, 10b arranged in the foreground. For illustration purposes, the elevator controller 8 is shown, which is connected to the door elements 9a, 9b of the car doors 10a, 10b and the shaft door elements 6a, 7a of the shaft doors 6, 7. Each of the car doors 10a, 10b has a frame structure 26, which partially or substantially completely surrounds the door element 9a, 9b laterally (as shown in FIG. 2). In this exemplary embodiment, the door element 9a, 9b occupies almost the entire vertical surface of the car door 10a, 10b. Accordingly, each of the shaft doors 6, 7 shown in FIG. 2 has a frame structure 28, which partially or substantially completely surrounds the shaft door element 6a, 7a laterally (as shown in FIG. 2).

In the exemplary embodiment described here, each door element 6a, 7a, 9a, 9b comprises a special glass, the visual permeability of which can be changed as a whole by being controlled by an electrical control signal, the control being effected in particular by an applied electrical voltage. A suitable voltage (e.g., in terms of voltage value and frequency) can be provided by the elevator controller 13 or by a voltage source arranged on or near the doors 6, 7, 10a, 10b. In the latter case, the elevator controller 13 can control the voltage sources. Depending on the electrical voltage applied, the glass is transparent or opaque or non-transparent. The properties “transparent” and “opaque” refer to the range of the electromagnetic spectrum that is visible to humans. In FIG. 2, for illustration. the door element 9a of the car door 10a is shown in a transparent state (e.g., it is translucent) and the door element 9b of the car door 10b is shown in an opaque state: the opaque state is shown in FIG. 2 by hatching. Correspondingly, the shaft door elements 6a, 7a of the shaft doors 6, 7 are shown in FIG. 2.

This type of glass is also known as smart, dynamic or switchable glass. This can be an electrochromic glass or a liquid crystal glass, for example, wherein the light transmission of these glasses can be changed by applying an electrical voltage. Without voltage applied, the liquid crystal glass can be opaque, for example. For example, US 2021/302770 A1 describes a modular wall system comprising a frame and a smart glass pane. An electrical connecting element is attached to a cross strut of the frame, which is connected to an electrical connecting element on the smart glass pane. The wall system also comprises a power connection to receive a direct current (DC) input voltage from a power source. An inverter converts the DC input voltage into an alternating voltage (AC). which is applied to the smart glass pane.

The elevator system I can be equipped with an up/down controller or a destination call controller. A person skilled in the art recognizes that mixed forms of the aforementioned control technologies can also be possible. If the elevator system 1 is equipped with an up/down controller, elevator operating devices 4 can be arranged on the floors L, L0, Ln, at which the desired direction of travel (e.g., an elevator call (direction call)) can be specified. For illustration purposes, such an elevator operating device 4 is shown in FIG. 1 on the floor L in the part of the building R. The boarding floor or the part of the building B, R on this boarding floor can be determined by the location of the elevator operating device 4, which is documented in the building plan, for example. The desired destination floor can then be input in the car 10 on an elevator operating device arranged there (not shown in FIG. 1); such a call input is also referred to as a car call. A communication line can connect the (car-side) elevator operating device to the elevator controller 13. The drive controller 8 can control the movement of the elevator car 10 according to the destination floor input in the car 10.

If the elevator system 1 is equipped with a destination call controller, elevator operating devices 4 can be arranged on the floors L, L0, Ln on which a passenger P can input a desired destination floor: a destination call can then be registered as an elevator call. For illustration purposes, such elevator operating devices 4 are shown in FIG. 1 on floors L0, Ln and on floor L in the part of the building B. Once the passenger has entered the destination floor, information about the entry floor and the destination floor can be available. The entry floor or the part of the building B, R on this entry floor can be determined by the location of the elevator operating device 4 (e.g., from the building plan) at which the destination floor is entered. The control and processing device 12 shown in FIG. 1 can serve as a destination call controller that assigns an elevator car 10 to the entered destination call. The drive controller 8 can control the movement of the elevator car 10 according to the destination call.

In order to transport a passenger, the elevator controller 13 can move the elevator car 10 according to the entry floor and the destination floor. The elevator controller 13, in particular the drive controller 8, can cause, among other things, the elevator car 10 to accelerate and brake or stop (according to a defined travel curve or travel profile) and the opening of a car door 10a, 10b depending on a (current) position of the elevator car 10 in the elevator shaft 18 and the next stopping floor. Braking of the elevator car 10 can be initiated, for example, if the car 10 is located within a floor zone defined for the stopping floor. In the elevator system 1, a corresponding functionality can be provided for position determination: in FIG. 1, this functionality is implemented with the position determining device 20, which can be assigned to the elevator controller 13, for example, for the purposes of illustration.

Methods and devices for determining the position of the elevator car 10 are known to a person skilled in the art, including, for example, magnetic tape-based measuring systems and laser-based optical measuring systems. With magnetic tape technology, a sensor mounted on the elevator car detects the current absolute car position using Hall sensors. which contactlessly scan a magnetic tape mounted in the shaft. A laser-based optical measuring system is known, for example, from DE 10126585 A1. This disclosure uses a system with a laser and a detector in order to determine a distance from a measured light travel time and from this a position of an elevator car. In the elevator system 1 according to the present disclosure. one of these measuring systems can be used in the position determining device 20. A person skilled in the art will recognize that the position determining device 20 and/or components of the position determining device 20 can be arranged outside the elevator controller 13 and/or distributed in the elevator system 1. The representation of the position determining device 20 in the elevator controller 13 is therefore to be understood as exemplary.

With an understanding of the system components of the elevator system 1 described above and their functionalities, exemplary embodiments of exemplary uses are described herein. FIG. 4 provides a description of an exemplary method for operating the elevator system 1. The elevator system 1 and the use of the building 2 can be configured as shown by way of example in FIG. 1. In the following description of the exemplary method shown in FIG. 4. the door elements 6a, 7a, 9a, 9b comprise the above-mentioned smart glasses; their visual permeability states are therefore referred to below as transparent and opaque. A person skilled in the art will recognize that the above-mentioned slat systems 30 can be used instead of smart glasses.

In FIG. 4. the method is shown by means of an exemplary flowchart with a number of steps. A person skilled in the art will recognize that the division into these steps is by way of example, and that one or more of these steps may be divided into one or more sub-steps, or that several of the steps may be combined into one step. Some steps can also be performed in a different order than shown, and some steps can be performed substantially simultaneously. The method begins with a step S1 and ends with a step S8.

The elevator controller 13 determines which of the two car doors 10a, 10b is to be opened when the elevator car 10 next stops. This occurs in response to an elevator call received from the elevator controller in step S2. Depending on the control technology, this can be a destination call or a car call, as explained above. Based on the destination floor, the elevator controller 13 determines in step S3 the car door 10a, 10b to be opened for operating the elevator call when it stops at the destination floor. The stored building plan can be used for this purpose, for example. Information about the car door 10a, 10b to be opened can be stored in order to generate a door control signal—when the car door 10a, 10b is stopped on the destination floor or when the car door 10a, 10b is moving to the destination floor-with which the car door 10a, 10b to be opened can be controlled.

In this exemplary embodiment, the stop mentioned in connection with step S3 is the destination floor resulting from the elevator call received. If the elevator car 10 is already serving another elevator call or if another elevator call is added, the car door 10a, 10b to be opened is also determined for these elevator calls. The elevator controller 13 determines the next floor or floors and the car door 10a, 10b to be opened.

In step S4, the elevator controller 13 controls the movement of the elevator car 10 according to the elevator call received in step S2. If a plurality of elevator calls are to be operated, a person skilled in the art will recognize that the elevator controller 13 also controls the movement of the elevator car 10 according to these elevator calls and the associated destination floors. The elevator car 10 is moved in accordance with the travel profile specified for this purpose in the elevator system 1 and the position of the elevator car 10 determined by the position determining device 20.

In step S5, a position of the elevator car 10 in the elevator shaft 18 is determined. This is effected with the position determining device 20 installed in the elevator system 1, as described herein. A person skilled in the art will recognize that the position is determined continuously while moving.

In step S6, the car position determined in step S5 is used to check whether the car 10 is located in a defined floor zone of the stopping floor. If this is not the case, the method returns along the “No” branch to step S5. However, if the car 10 is located in the floor zone of the stopping floor, the method proceeds along the “Yes” branch to step S7.

In one exemplary embodiment, the defined floor zone of the stopping floor can correspond to the above-mentioned floor zone defined for braking the car 10. In a further exemplary embodiment, the defined floor zone can differ from the floor zone defined for braking. This can make it possible to take into account that a door element 9a, 9b may require more or less time to change from the opaque state to the transparent state, for example.

In one exemplary embodiment, the elevator controller 13 can send the door control signal determined in connection with step S3 if the car 10 is in the floor zone of the stopping floor, for example, as soon as it enters the floor zone. In a further exemplary embodiment. the elevator controller 13 can send the door control signal if the car 10 is already on the stopping floor. In step S7, the door element 9a, 9b of the car door 10a, 10b to be opened can then be controlled in accordance with the transparent state.

According to the present disclosure, the floor zones and the control can be defined in such a way that the relevant door element 9a, 9b is transparent if the car 10 is on the destination floor. Depending on the configuration, the door element 9a, 9b of the car door 10a, 10b to be opened can be controlled in accordance with the transparent state when entering the floor zone. The method ends at step S8.

In the situation shown in FIG. 1 and according to an exemplary embodiment of the elevator system 1 and its mode of operation, the elevator system I can be used by residents and other persons, e.g., in the case of a building with mixed use, without them meeting or becoming aware of one another when using the elevator system 1. According to one exemplary embodiment, for example according to FIG. 4, the present disclosure can enable residents and other persons to be guided and directed. If, for example, a resident uses the elevator system 1 for a ride between a residents' floor and the (residents') entrance hall, the door element 9a, 9b of the car door 10a, 10b can become transparent, e.g., during the ride to the next stop, which will open, The other car door 10a, 10b, however, can remain opaque. The door elements 9a, 9b of the car doors 10a, 10b can be controlled in an analogous manner if a person is transported between a commercial floor and the (commercial) entrance hall. According to the present disclosure, a transparent or a door element 9a, 9b that becomes transparent can indicate to a passenger (resident or other person) in the elevator car 10 which car door 10a, 10b will open at the next stop: the present disclosure thus can prepare the passenger for disembarking and can guide the passenger towards the exit side.

According to one exemplary embodiment, the present disclosure can prevent passengers from seeing or looking into parts of the building (B, R) that are unfamiliar to the passengers in the building with mixed use described herein. The controller 11 can control the door elements 9a, 9b of the car doors 10a, 10b and the shaft door elements 6a, 7a of the shaft doors 6, 7 in such a way that, for example, a resident may not see onto a commercial floor during the ride or when the car stops. This can also apply in an analogous manner to a person who uses a commercial floor. In one exemplary embodiment, the shaft door elements 6a, 7a of the shaft doors 6, 7 can be opaque, except if an elevator car 10 with a car door 10a, 10b to be opened is located behind it or shortly before the elevator car 10 arrives. The shaft door element 6a, 7a of a shaft door 6, 7 to be opened can be in a transparent state when the elevator car 10 stops. If the door elements 6a, 7a, 9a, 9b of the doors to be opened (6, 7, 10a, 10b) are transparent, boarding passengers can see whether passengers are disembarking, for example; this can also apply in the opposite direction.

In addition, in the case of shaft doors 6, 7, which are arranged opposite the car doors 10a, 10b, the relevant door elements 6a, 7a, 9a, 9b can be controlled in such a way that at no time is it possible to see across the elevator shaft 18 to the other part of the building.

When using the elevator system 1, a resident therefore may not see that the ride passes. begins or ends on a floor that is used wholly or partially for commercial purposes. The privacy of the various user groups can therefore be preserved.

The resident in the above example can input an elevator call on a residents' floor or in an entrance hall, in order to travel from there to the entrance hall or to a residents' floor. The elevator controller 13 can recognize (e.g., in conjunction with the building plan) on which floor (boarding floor) and on which elevator operating device 4 the resident inputs the elevator call, and can cause the elevator car 10 to move to the boarding floor. If the elevator car 10 is already on the boarding floor, it may not be necessary to move the elevator car 10. Since the elevator controller 13 may also recognize the elevator operating device 4 operated by the resident, e.g., it may recognize on which side of the boarding floor the resident is waiting (e.g., in the part of the building R), it may control the car door 10a, 10b to be opened to this side. According to the present disclosure, the elevator controller 13 may control the door element 9a, 9b of this car door 10a, 10b in such a way that the door element 9a, 9b is transparent if the elevator car 10 arrives at the boarding floor and the car door 10a, 10b is opened, or if the car door 10a, 10b of the elevator car 10 already standing there is opened. The door element 9a, 9b of the other car door 10a, 10b. on the other hand, can be controlled so that it is opaque. Once the elevator car 10 is ready for boarding, e.g., the shaft door 6b and the car door 10a can open, the resident can enter the car 10 and can be transported to the desired destination floor, as described, for example, in connection with FIG. 4. Depending on the control technology, the destination floor can be transmitted to the elevator controller 13 in conjunction with a destination call or a car call.

The position determination can be used to adjust the visual permeability settings during a ride, e.g., to ensure privacy. In one exemplary embodiment, the use of a floor or part of a building defined in the building plan can be used to determine whether the ride passes at least one floor or part of a building that is defined as visible or not visible in the building plan. The door elements 9a, 9b of the car door 10a, 10b and/or the shaft door elements 6a, 7a can be controlled while the car is moving in the first or second visual permeability state, depending on the use defined in the building plan. Whether a floor or part of a building is visible or not can be determined by individual persons or by a building manager. For example, commercially used floors may not be visible during the ride: this may apply to a ride by a resident who passes a commercial floor, but also to other persons (commercial users). In one exemplary embodiment, the visibility or non-visibility can be defined specifically for the user groups: for example, the “residents” user group can sec the residents floors from the elevator car, but not the commercial floors, and vice versa.

1-16. (canceled)

17. An elevator system, comprising:
an elevator car configured to move between floors of a building in an elevator shaft, wherein the elevator car comprises two car doors comprising electrically controllable door elements,
wherein a first car door is arranged on a first car wall and comprises a first electrically controllable door element,
wherein a second car door is arranged on a second car wall and comprises a second electrically controllable door element, and
wherein the first electrically controllable door element and the second electrically controllable door element each are configured to have at least two visual permeability states, wherein in a first visual permeability state, the electrically controllable door elements are configured such that a passenger can at least partially see through the electrically controllable door elements and wherein when the electrically controllable door elements are in a second visual permeability state, a passenger's view through the electrically controllable door elements is substantially obstructed; and
an elevator controller configured to control movement of the elevator car and is communicatively coupled to the electrically controllable door elements, wherein the elevator controller is configured to determine a car door to be opened and to control the electrically controllable door element of the car door to be opened in accordance with the first visual permeability state, in order to allow the passenger to see at least partially through the electrically controllable door element of the car door to be opened.

18. The elevator system of claim 17, wherein the elevator controller is configured to control the electrically controllable door element of a car door which is not to be opened in accordance with the second visual permeability state, in order to substantially obstruct the view through its electrically controllable door element.

19. The elevator system of claim 17, further comprising shaft doors configured to separate the floors from the elevator shaft, wherein two shaft doors comprising electrically controllable shaft door elements are arranged on at least one floor,
wherein a first shaft door is arranged on a first building wall and comprises a first electrically controllable shaft door element,
wherein a second shaft door is arranged on a second building wall and comprises a second electrically controllable shaft door element, and
wherein the first electrically controllable shaft door element and the second electrically controllable shaft door element are each configured to have the at least two visual permeability states, wherein in the first visual permeability state, the electrically controllable shaft door elements are configured such that the passenger can at least partially see through the electrically controllable shaft door elements and wherein the second visual permeability state substantially obstructs the passenger's view through the electrically controllable shaft door elements, and
wherein the electrically controllable shaft door elements are configured to assume the first visual permeability state in response to an electrical control signal indicating a shaft door to be opened, in order to allow the passenger to see at least partially through the electrically controllable shaft door element of the shaft door to be opened.

20. The elevator system of claim 18, further comprising shaft doors configured to separate the floors from the elevator shaft, wherein two shaft doors comprising electrically controllable shaft door elements are arranged on at least one floor,
wherein a first shaft door is arranged on a first building wall and comprises a first electrically controllable shaft door element,
wherein a second shaft door is arranged on a second building wall and comprises a second electrically controllable shaft door element, and
wherein the first electrically controllable shaft door element and the second electrically controllable shaft door element are each configured to have the at least two visual permeability states, wherein in the first visual permeability state, the electrically controllable shaft door elements are configured such that the passenger can at least partially see through the electrically controllable shaft door elements and wherein the second visual permeability state substantially obstructs the passenger's view through the electrically controllable shaft door elements, and
wherein the electrically controllable shaft door elements are configured to assume the first visual permeability state in response to an electrical control signal indicating a shaft door to be opened, in order to allow the passenger to see at least partially through the electrically controllable shaft door element of the shaft door to be opened.

21. The elevator system of claim 19, wherein each electrically controllable shaft door element is communicatively coupled to the elevator controller or wherein each electrically controllable shaft door element comprises an electrical shaft door contact element which is configured to be complementary to an electrical car door contact element arranged on or near each of the car doors, wherein the electrical shaft door contact element and the electrical car door contact element are configured to transmit the electrical control signal if the car door couples to the shaft door.

22. The elevator system of claim 21, wherein the elevator controller is configured to control the electrically controllable door element of the car door to be opened in accordance with the first visual permeability state, wherein the electrically controllable shaft door element of the shaft door to be opened is controlled in accordance with the first visual permeability state, in order to allow the passenger to see at least partially through the electrically controllable door elements of the car door and shaft door to be opened.

23. The elevator system of claim 21, wherein the elevator controller is configured to control the electrically controllable door element of the car door not to be opened in accordance with the second visual permeability state, wherein the electrically controllable shaft door element of the shaft door not to be opened is in the second visual permeability state.

24. The elevator system of claim 22, wherein the elevator controller is configured to control the electrically controllable door element of the car door not to be opened in accordance with the second visual permeability state, wherein the electrically controllable shaft door element of the shaft door not to be opened is in the second visual permeability state.

25. The elevator system of claim 17, wherein the electrically controllable door elements comprise glass inserts inserted into the car doors, wherein the glass inserts comprise a smart glass, which is substantially transparent in the first visual permeability state and is substantially opaque in the second visual permeability state.

26. The elevator system of claim 17, wherein the electrically controllable door elements comprise electromechanically adjustable slat systems inserted into the two car doors, wherein in the first visual permeability state, slats of the electromechanically adjustable slat systems are configured to be adjustable such that substantially there is visual permeability and in the second visual permeability state, the slats are configured to be adjustable such that substantially there is no visual permeability.

27. The elevator system of claim 17, further comprising a position determining device which is configured to determine a position of the elevator car in the elevator shaft, wherein the elevator controller is configured to control the electrically controllable door element of the car door to be opened while the elevator car is moving to a floor on which the elevator car is to stop, in such a way that a change to the first visual permeability state takes place depending on the position and the floor on which the elevator car is to stop while the elevator car is moving.

28. The elevator system of claim 17, wherein the two car doors each comprise a frame structure which is configured to support the electrically controllable door element and with which the car door is arranged on the car wall, in particular, the electrically controllable door element of the first car door and the electrically controllable door element of the second car door each comprise a vertical surface in the frame structure which substantially corresponds to a vertical surface of the car door.

29. A method for operating the elevator system of claim 17, wherein the elevator system comprises the elevator controller and the elevator car, wherein the elevator car, controlled by the elevator controller, is configured to move between the floors of the building in the elevator shaft and comprises the two car doors comprising the electrically controllable door elements, wherein the first car door is arranged on the first car wall and comprises the first electrically controllable door element, wherein the second car door is arranged on the second car wall and comprises the second electrically controllable door element, and wherein the first electrically controllable door element and the second electrically controllable door element are each configured to have the at least two visual permeability states, wherein in the first visual permeability state, the electrically controllable shaft door elements are configured such that the passenger can at least partially see through the electrically controllable door element and wherein the second visual permeability state substantially obstructs the passenger's view through the electrically controllable door element; wherein the method comprises:
determining, by the elevator controller, which of the two car doors is to be opened at a next stop of the elevator car, and generating a door control signal indicating the car door to be opened; and
controlling the electrically controllable door element of the car door to be opened with the door control signal in accordance with the first visual permeability state, in order to allow the passenger to at least partially see through the electrically controllable door element of the car door to be opened.

30. The method of claim 29, further comprising controlling the door element of a car door not be opened in accordance with the second visual permeability state by the elevator controller, in order to substantially obstruct the passenger's view through the electrically controllable door element of the car door not to be opened.

31. The method of claim 29, wherein the elevator system further comprises shaft doors which separate the floors from the elevator shaft, wherein on at least one floor a first shaft door is arranged on a first building wall and comprises a first electrically controllable shaft door element, wherein a second shaft door is arranged on a second building wall and comprises a second electrically controllable shaft door element, wherein the first electrically controllable shaft door element and the second electrically controllable shaft door element are each configured to have the at least two visual permeability states, and wherein the elevator controller is communicatively coupled to and configured with the first electrically controllable shaft door element and the second electrically controllable shaft door element, wherein the method further comprises:
controlling the electrically controllable shaft door element of a shaft door to be opened corresponding to the car door to be opened in accordance with the first visual permeability state, in order to allow the passenger to at least partially see through the electrically controllable shaft door element of the shaft door to be opened.

32. The method of claim 30, wherein the elevator system further comprises shaft doors which separate the floors from the elevator shaft, wherein on at least one floor a first shaft door is arranged on a first building wall and comprises a first electrically controllable shaft door element, wherein a second shaft door is arranged on a second building wall and comprises a second electrically controllable shaft door element, wherein the first electrically controllable shaft door element and the second electrically controllable shaft door element are each configured to have the at least two visual permeability states, and wherein the elevator controller is communicatively coupled to and configured with the first electrically controllable shaft door element and the second electrically controllable shaft door element, wherein the method further comprises:
controlling the electrically controllable shaft door element of a shaft door to be opened corresponding to the car door to be opened in accordance with the first visual permeability state, in order to allow the passenger to at least partially see through the electrically controllable shaft door element of the shaft door to be opened.

33. The method of claim 31, further comprising controlling the electrically controllable door element of a car door not to be opened and the electrically controllable shaft door element of a shaft door not to be opened in accordance with the second visual permeability state, in order to substantially obstruct the passenger's view through the electrically controllable door elements and the electrically controllable shaft door elements.

34. The method of claim 29, further comprising:
determining a position of the elevator car in the elevator shaft by a position determining device; and
controlling the electrically controllable door element of the car door to be opened during a ride from a boarding floor to a stopping floor on which the elevator car is to stop, so that a change to the first visual permeability state takes place depending on the position and the stopping floor while the elevator car is moving.

35. The method of claim 30, further comprising:
determining a position of the elevator car in the elevator shaft by a position determining device; and
controlling the electrically controllable door element of the car door to be opened during a ride from a boarding floor to a stopping floor on which the elevator car is to stop, so that a change to the first visual permeability state takes place depending on the position and the stopping floor while the elevator car is moving.

36. The method of claim 34, further comprising:
determining, with a use of a floor or a part of a building defined in a building plan, whether the floor or the part of the building defined in the building plan is defined as visible on non-visible in the building plan as the ride passes the floor or the part of the building defined in the building plan; and
controlling at least one of the electrically controllable door element of the car door or an electrically controllable shaft door element during the ride in the first visual permeability or second visual permeability state depending on the position and the use of the floor or the part of the building defined in the building plan.
